(19) United States
(12) Patent Application Publication
(10) Pub. No.: US 2011/0079104 A1
(43) Pub. Date: Apr. 7, 2011

(54) Zero turn radius riding lawn mower dual foot pedal control

(76) Inventor: Henry Clyde Sama, Gray, GA (US)

(21) Appl. No.: 12/588,103

(22) Filed: Oct. 5, 2009

(51) Int. Cl. G05G 1/30

(52) U.S. Cl. 74/512

(57) ABSTRACT

The nature of the technical disclosures of the invention is to introduce into the market something that is not available now, namely a dual pedal foot operated zero-turn radius riding lawn mower. The foot pedal operated model will have a distinct advantage in comfort for operators that must use their mowers for sustained periods of time such as cutting grass on large areas. The current market mower models are operated with hand and arm motions that are tedious and tiresome to use and can aggravate certain health issues for some operators. In addition, by not requiring the hands for operation, safety is greatly increased by allowing operators to prevent low hanging tree limbs or branches from striking their body or head areas.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Due to severe arthritis in my hands, wrists, joints, and shoulders and because it was my responsibility to cut the grass on multiple plats of land with large acreage for my personal and the rental properties that I owned, I found it necessary to try to discover a way to use the riding mower without having to use my hands or arms as typically needed with the zero turn radius lawn mower.

### BRIEF SUMMARY OF THE INVENTION

The invention is intended to alleviate pain and discomfort of having to extend the hands and arms for long periods of time. It would be helpful for handicapped and non-handicapped operators of the equipment that suffer from arthritis, tendinitis or joint stiffness.

### BRIEF DESCRIPTION OF THE SEVERAL VIEWS OF THE DRAWING

Figures on drawing are shown as numeric-alpha:

FIG. 1-A: Front of foot pedal

FIG. 1-A1: Toe end cap on front of foot pedal

FIG. 1B: Rear of foot pedal

FIG. 1-B1: Heel rest on rear of foot pedal

FIG. 1-C: Spacer plate

FIG. 1-D: Petal Base plate

FIG. 1-E: Spacer plate

FIG. 1-F: Connector arm

FIG. 1-G: Two (2) piece angle iron

FIG. 1-H: Swivel

FIG. 1-I: Connector rod

FIG. 1-J: Pump arm

FIG. 1-K: Four (4) ⅜″×1½″ long Bolt

FIG. 1-L: Four (4) ⅜″ Lock nut

FIG. 1-M: Two (2) ⅜″×2″ long Bolt

FIG. 1-N: Two (2) ⅜″ Lock nut

FIG. 1-O: Two (2) ⅜″ Fine thread Lock Nut

FIG. 1-P: Two (2) ⅜″ Fine thread jamb nuts

FIG. 1-Q(a): Right mounting bracket

FIG. 1-Q(b): Left mounting bracket

FIG. 1-R: Rocker arm

FIG. 1-S: Upper Connecting Rod

### DETAILED DESCRIPTION OF THE INVENTION

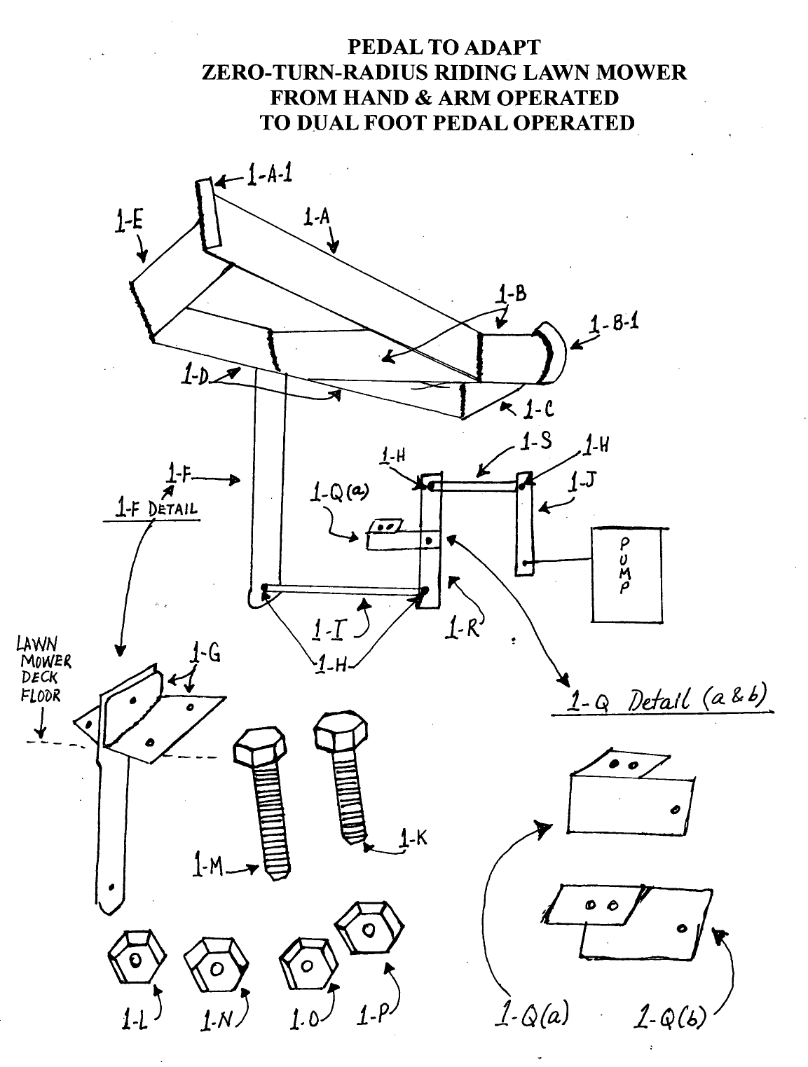

FIG. 1-A is the front of the foot pedal and measures 8½ inches long×3¼ wide×¼ inch thick. It is welded on one end to FIG. 1-B and to Spacer Plate FIG. 1-E. FIG. 1-A1 toe end cap is 1 inch high by 3¼ inches wide and is ¼ inch thick. It is welded to the end of FIG. 1-A. FIG. 1-B is the rear of the foot petal and measures 8½ inches long×3¼ inches wide×¼ inch thick. It is welded to 1-A on one end and to Spacer plate 1-C at a 45 degree angle and the other end is welded to 1-D. FIG. 1-B1 heel rest is ½ inch high and is 3¼ inches wide and is welded to the rear of FIG. 1-B. The other end of 1-C is welded to 1-D. 1-C is 3 inches high×3¼ inches wide×¼ inch thick. 1-D is the base plate for the main pedal. FIG. 1-D is 9 inches long×3 inches wide×¼ inch thick. 1-E is 3 inches high×3¼ inch wide×¼ inch thick. It is necessary to cut a ½ inch wide×4 inch long hole in the lawn mower deck in order to insert connector arm from underneath mower deck to above deck and between both pieces of FIG. 1-G. Spacer plate 1-E is welded to 1-D and 1-A. 1-F is the Connector arm welded to the bottom center of base plate 1-D, it measure 3 inches wide×3 inches high×¼ inch thick. The entire length of piece 1-F is 9 inches including the portion above and below the deck. The portion of 1-F that is below the deck is 5 inches and has a ⅜ inch hole centered in it 1 inch from the bottom. The larger portion of the piece above the deck at the top has a ⅜ inch hole centered 1 inch from the top. That top portion that is above the deck is 3 inches wide×4 inches high×¼ inches thick. The narrower portion that is below the deck is 5 inches long×1 inch wide×¼ inch thick. 1-G is the 3 inch×2 inch×¼ inch thick angle iron. The 2 inch portion is bolted to the deck with two ⅜ inch holes. The rising portion is 3 inches high×3 inches wide×¼ inch thick. It has one ⅜ inch hole drilled ½ inch from the top. Note that it is very important that the upper corners of the rising 3 inch angle iron must be rounded on both sides so that the pedal will rock. 1-H is the ⅜ inch swivel that is mounted in the ⅜ inch hole at the bottom of FIG. 1-F and is secured with a ⅜ inch lock nut. One end of FIG. 1-I Connector Rod is screwed into the swivel that is joining FIG. 1-F and is secured with a ⅜ inch jamb nut. FIG. 1-I is a ⅜ inch fine thread rod and is 29 inches long. The other end of FIG. 1-I is screwed to FIG. 1-H using a ⅜ inch swivel with a ⅜ inch jamb nut. This swivel is fastened to the bottom of FIG. 1-R Rocker arm using the ⅜ inch hole. The swivel is secured with a ⅜ inch lock nut. FIG. 1-R rocker arm is 10 inches long×1¼ inches wide×¼ inch thick. There are three ⅜ inch holes drilled into FIG. 1-R Rocker arm. There will be one ⅜ inch hole drilled ½ inch from each end of the FIG. 1-R rocker arm and the third hole will be in the center of FIG. 1-R rocker arm 4½ inches centered. FIG. 1-Q(a) is a right angle iron for the right-side Mounting bracket for the 1-R Rocker arm center hole. FIG. 1-R is secured to the FIG. 1-Q(a) bracket with a ⅜ inch bolt % inches long and is secured with a ⅜ inch lock nut. FIG. 1-Q(b) is a left angle iron for the left-side Mounting bracket for the 1-R Rocker arm center hole. FIG. 1-R is secured to the FIG. 1-Q(b) bracket with a ⅜ inch bolt % inches long and is secured with a ⅜ inch lock nut. The right and left angle iron Mounting brackets are mounted to the existing frame location where the brake assembly bolt hinges to the frame. The upper portion of both Mounting Bracket FIGS. 1-Q(a) and 1-Q(b) are 2 inches high×3 inches long×¼ inch thick. The lower portion of both Mounting brackets FIGS. 1-Q(a) and 1-Q(b) is 6 inches long×2 inches high×¼ inch thick. The upper portion of both Mounting Brackets FIG. 1-Q(a) and FIG. 1-Q(b) have two ⅜ inch holes drilled into it with each being one inch from the end. The lower portion has one ⅜ inch hole drilled 1 inch from the end that is furtherest from the upper portion. The swivel FIG. 1-H will mount in the ⅜ hole with a ⅜ inch lock nut at the top of the rocker arm FIG. 1-R. FIG. 1-S will screw into the swivel at FIG. 1-R and is secured by a ⅜ inch jamb nut. The other end of FIG. 1-S will connect to FIG. 1-H swivel and will be secured by a ⅜ inch jamb nut and will connect to the FIG. 1-J pump arm and is secured with a ⅜ inch lock nut and goes into the existing hole where the existing hand control rod was mounted. The Mounting Brackets, FIGS. 1-Q(a) and 1-Q(b) are bolted in the center hole of FIG. 1-R and fastened with a ⅜ inch bolt % inches long and secured with a ⅜ inch lock nut underneath the frame that the brake plate is mounted to. FIG. 1-Q(a) and FIG. 1-Q(b) each takes two ⅜ inch fine thread bolts that are ¾ inches long and are secured with two ⅜ inch lock nuts. It is necessary to cut a slot ½ inch wide×1 inch long in the upper front portion of both angles of the Mounting bracket facing the long piece to accommodate the existing brake assembly bolt allowing it to go through the angle iron Mounting bracket. The upper portion of FIG. 1-R Rocker arm is connected to FIG. 1-S with a ⅜ inch swivel through a ⅜ inch hole in the Rocker arm. It is then connected to FIG. 1-S with a ⅜ inch lock nut. A swivel is connected to FIG. 1-S and is secured with a ⅜ inch fine thread jamb nut. FIG. 1-S is a fine thread Connecting Rod that is 8% inches long. The FIG. 1-S Connecting Rod is screwed to the ⅜ inch swivel and it is secured with a ⅜ inch jamb nut. The swivel is connected to the FIG. 1-J pump arm and secured with a ⅜ inch fine thread lock nut. The swivel is installed into the existing pump arm FIG. 1-J. Note that the existing hand control rod must be removed from the FIG. 1-J pump arm and the swivel goes into that existing hole.

The mower is operated in its entirety by the use of both feet and does not require use of the hand or arms for operation. The only hand or arm movement required would be to release the brakes to start the mowing cycle and to apply the brakes when the mower has been powered down.

After starting the engine, the steering operation of the zero turn radius riding lawn mower is accomplished as follows:

To go straight forward, apply pressure simultaneously to the front of foot pedal FIG. 1-A using both right and left pedals and this also controls the forward acceleration speed.
To go straight back in reverse, apply pressure simultaneously to the rear of foot pedal FIG. 1-B using both right and left pedals. This controls the mower reverse acceleration speed.
To go forward and turn left, apply pressure with the ball of the right foot to front of right pedal FIG. 1-A and apply pressure with heel of left foot to rear of left pedal FIG. 1-B.
To go forward and turn right, apply pressure with the ball of the left foot to front of left pedal FIG. 1-A and apply pressure with heel of right foot to rear of right foot pedal FIG. 1-B.
To pivot turn to the right, apply pressure simultaneously with the ball of the left foot to the front of the left foot pedal FIG. 1-A and the heel of right foot to the rear of right pedal FIG. 1-B. This will result in a clock-wise zero turn radius of the mower.
To pivot turn to the left, apply pressure simultaneously with the ball of the right foot to the front of the right foot pedal FIG. 1-A and the heel of the left foot to the rear of the left pedal FIG. 1-B. This will result in a counter-clockwise zero turn radius of the mower.
To increase speed, apply pressure with both feet to the front of both pedals at FIG. 1-A
To decrease speed, apply pressure with the heel of both feet to the rear of both pedals at FIG. 1-B.
To come to a stop, apply pressure in a rocking motion with both feet simultaneously to the front of pedal FIG. 1-A and the rear of pedal FIG. 1-B using both left and right foot pedals.

### DETAILED DESCRIPTION OF THE INVENTION

FIG. 1-A is the front of the foot pedal and measures 8½ inches long×3¼ wide×¼ inch thick. It is welded on one end to FIG. 1-B and to Spacer Plate FIG. 1-E. FIG. 1-A1 toe end cap is 1 inch high by 3¼ inches wide and is ¼ inch thick. It is welded to the end of FIG. 1-A. FIG. 1-B is the rear of the foot petal and measures 8½ inches long×3¼ inches wide×¼ inch thick. It is welded to 1-A on one end and to Spacer plate 1-C at a 45 degree angle and the other end is welded to 1-D. FIG. 1-B1 heel rest is ½ inch high and is 3¼ inches wide and is welded to the rear of FIG. 1-B. The other end of 1-C is welded to 1-D. 1-C is 3 inches high×3¼ inches wide×¼ inch thick. 1-D is the base plate for the main pedal. FIG. 1-D is 9 inches long×3 inches wide×¼ inch thick. 1-E is 3 inches high×3¼ inch wide×¼ inch thick. It is necessary to cut a ½ inch wide×4 inch long hole in the lawn mower deck in order to insert connector arm from underneath mower deck to above deck and between both pieces of FIG. 1-G. Spacer plate 1-E is welded to 1-D and 1-A. 1-F is the Connector arm welded to the bottom center of base plate 1-D, it measure 3 inches wide×3 inches high×¼ inch thick. The entire length of piece 1-F is 9 inches including the portion above and below the deck. The portion of 1-F that is below the deck is 5 inches and has a ⅜ inch hole centered in it 1 inch from the bottom. The larger portion of the piece above the deck at the top has a ⅜ inch hole centered 1 inch from the top. That top portion that is above the deck is 3 inches wide×4 inches high×¼ inches thick. The narrower portion that is below the deck is 5 inches long×1 inch wide×¼ inch thick. 1-G is the 3 inch×2 inch×¼ inch thick angle iron. The 2 inch portion is bolted to the deck with two ⅜ inch holes. The rising portion is 3 inches high×3 inches wide×¼ inch thick. It has one ⅜ inch hole drilled ½ inch from the top. Note that it is very important that the upper corners of the rising 3 inch angle iron must be rounded on both sides so that the pedal will rock. 1-H is the ⅜ inch swivel that is screwed onto the ⅜ inch fine thread rod. This swivel is mounted in the ⅜ inch hole at the bottom of 1-F. At the other end of 1-I the swivel is screwed into the fine thread rod. The swivel fastens to 1-J through a ⅜ inch hole. A ⅜ inch×4 inch hole must be cut through the frame to allow the ⅜ swivel to be connected underneath the mower frame to pump arm underneath frame of motor. The swivel is inserted 1 inch from the bottom into the ⅜ inch hole from the pump arm and secured by the ⅜ inch lock nut and the arm 1-J is the existing pump arm which will be turned 180 degrees toward the ground. FIG. 1-J is the existing Pump arm. The ⅜ inch rod is 37 inches long overall. The rod length will vary on different manufactured brands of zero turn radius riding lawn mowers. The 1-P jamb nuts go behind the swivel 1-I to prevent 1-I rod from turning.

The mower is operated in its entirety by the use of both feet and does not require use of the hand or arms for operation. The only hand or arm movement required would be to release the brakes to start the mowing cycle and to apply the brakes when the mower has been powered down.

After starting the engine, the steering operation of the zero turn radius riding lawn mower is accomplished as follows:

To go straight forward, apply pressure simultaneously to the front of foot pedal FIG. 1-A using both right and left pedals and this also controls the forward acceleration speed.
To go straight back in reverse, apply pressure simultaneously to the rear of foot pedal FIG. 1-B using both right and left pedals. This controls the mower reverse acceleration speed.
To go forward and turn left, apply pressure with the ball of the right foot to front of right pedal FIG. 1-A and apply pressure with heel of left foot to rear of left pedal FIG. 1-B.
To go forward and turn right, apply pressure with the ball of the left foot to front of left pedal FIG. 1-A and apply pressure with heel of right foot to rear of right foot pedal FIG. 1-B.
To pivot turn to the right, apply pressure simultaneously with the ball of the left foot to the front of the left foot pedal FIG. 1-A and the heel of right foot to the rear of right pedal FIG. 1-B. This will result in a clock-wise zero turn radius of the mower.
To pivot turn to the left, apply pressure simultaneously with the ball of the right foot to the front of the right foot pedal FIG. 1-A and the heel of the left foot to the rear of the left pedal FIG. 1-B. This will result in a counter-clockwise zero turn radius of the mower.
To increase speed, apply pressure with both feet to the front of both pedals at FIG. 1-A
To decrease speed, apply pressure with the heel of both feet to the rear of both pedals at FIG. 1-B.
To come to a stop, apply pressure in a rocking motion with both feet simultaneously to the front of pedal FIG. 1-A and the rear of pedal FIG. 1-B using both left and right foot pedals.

1. The invention is a conversion of a zero turn radius riding lawn mower from a hand and arm operated model to a dual foot pedal controlled version. My mower is the only model that has been adapted for foot pedal control and it is now highly effective, efficient, and fun and effortless to operate.

2. The foot controlled conversion has numerous advantages over the arm operated model. It is easier for a physically handicapped person that suffers from severe arthritis, rheumatism, arm, hand, joint, or shoulder stiffness or for diabetics that suffer from numbness of the hands to operate their lawn mower for sustained periods of time. It is also advantageous and a time saver to the operator to be able to pick up debris with a grabber while still sitting on the machine and the machine is moving. Prior to the conversion, the operator would have had to power the machine down, get off or reach out and pick up the debris while the machine was stopped.

3. With the foot pedal version the entire body is not as tired as with the arm operated model. The foot controlled model will do everything the hand operated model will but without the constant movements that are very tedious and tiring. In some areas where there are low hanging tree limbs or branches, this model really excels in convenience and safety since the operators hands are free at all times to protect his head and body area. Staying hydrated, snacking or talking on the cell phone is especially easy while being extra safe with this hands-free conversion too! I have turned my much dreaded lawn mowing chore into a fun job with the use of my foot pedal controlled zero turn radius riding mower.
